(19) United States
(12) Patent Application Publication
(10) Pub. No.: US 2015/0101162 A1
(43) Pub. Date: Apr. 16, 2015

(54) Caliper Pin Removal Tool

(71) Applicants: Bosch Automotive Service Solutions LLC, Warren, MI (US); Robert Bosch GmbH, Stuttgart (DE)

(72) Inventor: Lloyd Nelson, Whitewood (CA)

(21) Appl. No.: 14/504,735

(22) Filed: Oct. 2, 2014

Related U.S. Application Data
(60) Provisional application No. 61/889,560, filed on Oct. 11, 2013.

(51) Int. Cl. B25B 27/04

(52) U.S. Cl. CPC B25B 27/04
USPC 29/275

(57) ABSTRACT

A tool facilitates removal of a caliper pin from a brake caliper. The pin removal tool includes a tool head, an opening, and a shaft. The opening is defined in the tool head by a first and a second portion of the tool head, and the opening extending inwardly from a side of the tool head and between a proximal surface and a distal surface. The opening is sized to receive a shaft portion of a caliper pin therein while allowing the distal surface to abut a head of the caliper pin. The shaft has a longitudinal axis which is not parallel to the distal surface, and the shaft includes a first end portion rigidly connected to the tool head and a second end portion having a striking interface. The striking is interface configured to receive an impact force and transmit the impact force along the longitudinal axis.

### CLAIM OF PRIORITY

This application claims the benefit of priority to co-pending provisional application No. 61/889,560, filed on Oct. 11, 2013, the disclosure of which is incorporated herein by reference in its entirety.

### TECHNICAL FIELD

This disclosure relates generally to hand tools and, more particularly, automotive hand tools.

### BACKGROUND

A typical disc brake assembly includes a rotor secured to the wheel of the vehicle for rotation therewith. A caliper assembly is slidably supported by pins secured to an anchor plate, which is attached to a non-rotatable component of the vehicle, such as the steering knuckle or axle flange. The caliper assembly includes a pair of brake pads disposed on opposite sides of the rotor. The brake pads are operatively connected to one or more hydraulically actuated pistons for movement between a non-braking position, in which the brake pads are spaced apart from opposed braking surfaces of the rotor, and a braking position, in which the brake pads are moved into frictional engagement with opposed braking surfaces of the rotor. When the operator of the vehicle depresses the brake pedal, the piston urges the brake pads from the non-braking position to the braking position so as to frictionally engage the opposed braking surfaces of the rotor and thereby slow or stop the rotation of the associated wheel of the vehicle.

As mentioned above, the caliper assembly is slidably supported on pins secured to the anchor plate. A typical pin includes a non-threaded main body and threaded end. The main body of the pin extends into a non-threaded opening formed in the inboard leg of the caliper, and the threaded end of the pin is received in a threaded opening provided in the anchor plate.

In performing maintenance on the brake caliper, it is often necessary to remove the pin from the opening in which the pin is mounted. However, during operation, the pin may oxidize due to exposure to moisture during normal use and become seized in the associated opening. Removal of the pin can be difficult, and improper removal can result in damage to the caliper. Furthermore, the pin is typically located on a side of the caliper facing inwardly toward the vehicle when the caliper is mounted on the vehicle. As a result, generating sufficient force to remove the pin is difficult without removing the caliper from the vehicle. What is needed, therefore, is a tool for removing brake caliper pins from the brake caliper.

### SUMMARY

In one embodiment, a pin removal tool includes a tool head, an opening defined in the tool head by a first and a second portion of the tool head. The opening extends inwardly from a side of the tool head and between a proximal surface and a distal surface and the opening is sized to receive a shaft portion of a caliper pin therein while allowing the distal surface to abut a head of the caliper pin. The pin removal tool further includes a shaft having a longitudinal axis which is not parallel to the distal surface. The shaft has a first end portion rigidly connected to the tool head and a second end portion having a striking interface. The striking interface is configured to receive an impact force and transmit the impact force along the longitudinal axis.

In a further embodiment, the tool head includes a base portion, a first prong, and a second prong. The first prong and the second prong each extend from the base portion. The first prong and the second prong define at least a portion of the opening therebetween and define at least a portion of the distal surface.

In yet another embodiment, the first prong has a first end attached to the base portion and a second end opposite to the first end, and the second prong has a third end attached to the base portion and a fourth end opposite to the first end. A width of the opening decreases from a location proximate the second and fourth ends to a location proximate the first and third ends.

In another embodiment, the distal surface of the tool head is generally planar and is positioned in a plane that is at an angle of between 80 and 100 degrees to the longitudinal axis.

In a further embodiment, the distal surface of the tool head is orthogonal to the longitudinal axis.

In another embodiment of the pin removal tool, a height of the first prong along the longitudinal axis increases from a location proximate the second end to a location proximate the first end, and a height of the second prong along the longitudinal axis increases from a location proximate the fourth end to a location proximate the third end.

In some embodiments of the pin removal tool, the shaft includes a textured portion adjacent to the second end portion of the shaft.

In a further embodiment of the pin removal tool, the striking interface includes a striking surface generally orthogonal to the longitudinal axis.

In yet another embodiment, the striking interface includes a pneumatic hammer interface configured to receive the impact force from a pneumatic hammer.

In some embodiments, the distal surface of the tool head is arcuately shaped about a first axis of curvature that is generally orthogonal to the longitudinal axis, and the proximal surface of the tool head is arcuately shaped about a second axis of curvature that is generally orthogonal to the longitudinal axis.

A method of removing a brake caliper pin includes inserting a tool head between a head of a caliper pin and a body of a caliper such that a shaft portion of the caliper pin is received in an opening defined in the tool head by a first and a second portion of the tool head and between a proximal surface and a distal surface and abutting the head of the caliper pin with the distal surface. The method further includes transmitting an axial force to a striking interface located at a first end portion of a shaft, transferring the axial force along a longitudinal axis of the shaft from the first end portion to a second end portion of the shaft, diverting the axial force from the second end portion to the tool head, which is rigidly connected to the second end portion, and transmitting the axial force from the tool head to the head of the caliper pin through the abutment of the distal surface and the head of the caliper pin.

In one embodiment, the transmitting of the axial force to the striking interface includes impacting a planar surface that is generally orthogonal to the longitudinal axis of the shaft.

In another embodiment, the transmitting of the axial force to the striking interface includes attaching a pneumatic hammer to a pneumatic hammer interface of the striking interface and activating the pneumatic hammer.

In a further embodiment of the method, the inserting of the tool head includes inserting a first prong and a second prong, which define at least of a portion of the distal surface and of the opening, between the head of the caliper pin and the body of the caliper such that the first and second prongs engage opposite sides of the shaft portion of the caliper pin, and the transmitting of the axial force from the tool head to the head of the caliper pin includes transmitting the axial force to the head of the caliper pin through the first prong and the second prong.

In some embodiments, the inserting of the tool head includes inserting the first prong from a first end toward a second opposite end attached to a base portion of the tool head and inserting the second prong from a third end to a fourth opposite end attached to the base portion of the tool head, and the abutting of the head includes moving the first and second prongs such that the prongs move from a first portion of the opening proximate the first and third ends to a second portion of the opening proximate the second and fourth ends, the second portion of the opening having a width that is reduced from the first portion of the opening.

In yet another embodiment of the method, the inserting of the tool head includes inserting a first end of the first prong, which has a reduced height compared to a second end of the prong, between the head of the caliper pin and the body of the caliper, and inserting a third end of the second prong, which has a reduced height compared to a fourth end of the second prong, between the head of the caliper pin and the body of the caliper.

### BRIEF DESCRIPTION OF THE DRAWINGS

FIG. 1 is a top perspective view of a pin removal tool for use with a manual hammer.

FIG. 2 is a side perspective view of the pin removal tool of FIG. 1.

FIG. 3 is a side view of another pin removal tool for use with a manual hammer, illustrating the tool engaged with a caliper pin.

FIG. 4 is a top perspective view of a pin removal tool for use with a pneumatic hammer.

FIG. 5 is a side perspective view of the pin removal tool of FIG. 4.

FIG. 6 is a side view of another pin removal tool for use with a pneumatic hammer, illustrating the tool engaged with a caliper pin.

FIG. 7 is a side view of another embodiment of a pin removal tool having an arcuate head.

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

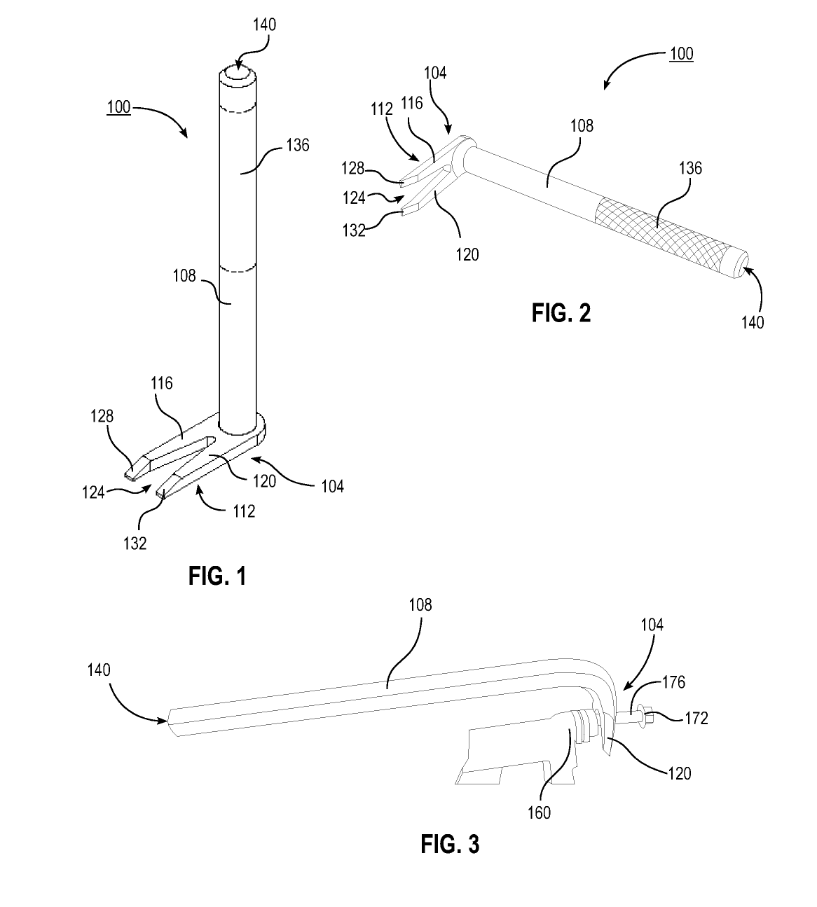

FIGS. 1 and 2 illustrate perspective views of a pin removal tool 100 having a head 104 and a shaft 108. In the illustrated embodiment, the head 104 extends in a plane orthogonal to a longitudinal axis of the shaft 108. In other embodiments, the head is angled relative to the plane orthogonal to the longitudinal axis of the shaft, for example at an angle of between 80 and 100 degrees with respect to the longitudinal axis of the shaft, or the head has a nonplanar shape. In the embodiment of FIG. 2, the head 104 and the shaft 108 are separate pieces joined together by, for example, a weld. In another embodiment illustrated in FIG. 3, the head 104 and shaft 108 are integrally formed from a single piece of material. The tool 100 is formed from a suitable hardened material, for example a tool steel or other steel alloy.

The tool head 104 includes a distal surface in the form of a generally flat engagement face 112 defined at least in part by a first prong 116 and a second prong 120, both of which extend away from the intersection of the tool head 104 and shaft 108. In the illustrated embodiment, outer surfaces of the first prong 116 and second prong 120 are substantially parallel to one another, though in other embodiments the prongs are angled relative to one another. The prongs 116, 120 are tapered at end regions 128, 132 remote from the shaft 108, such that a height of the prongs 116, 120, defined parallel to the longitudinal axis of the shaft 108, is less at the ends 128, 132 of the prongs 116, 120. Additionally, the prongs 116, 120 have a tapered width, such that the width of the prongs 116, 120 is greater at the end nearest the intersection of the tool head 104 and shaft 108, and less at the opposite ends 128, 132 of the prongs 116, 120. As a result, an opening 124 defined between the prongs is narrower at the end near the intersection of the tool head 104 and shaft 108 than at the opposite end of the tool head 104.

The tool shaft 108 is substantially cylindrical in the embodiments of FIGS. 1 and 2, and includes a textured portion 136 (best seen in FIG. 2) for enhanced grip of the tool 100. In the embodiment of FIG. 3, the tool shaft has a hexagonal cross section, while in other embodiments the tool shaft has another shape or a non-uniform cross section. The end of the shaft 108 opposite the tool head 104 has a substantially flat striking face 140 oriented in a plane generally orthogonal to the shaft 108 of the tool 100.

FIG. 3 illustrates the tool 100 in use. The tool 100 is positioned such that the ends 128, 132 of the prongs 116, 120 are wedged between the head of a caliper pin (not visible in FIG. 3) and the body of the caliper 160. In this configuration, the distal surface of the prongs 116, 120 abut the head of the caliper pin while the shaft of the caliper pin is received within the opening 124. The tool head 104 is then pressed downwardly in the view of FIG. 3 until the distal engagement face 112 is securely engaged with the head of the caliper pin. The tapered end regions 128, 132 facilitate wedging the prongs 116, 120 under the head of the caliper pin. If the tool cannot be wedged between the pin head and the caliper 160 with manual force, the tool head 104 is hammered at the end near the shaft 108 to force the tool 100 between the pin head and caliper body 160. In some instances, the tool 100 is wedged between the head 172 of a caliper mounting bolt 176 and the head of the caliper pin, for example if the caliper pin is damaged, to remove the mounting bolt 176 from the caliper pin. Since the opening 124 in the tool head 104 is tapered, the tool 100 is suitable for use with pins and bolts having various head diameters and shapes.

The tool head 104 is wedged between the pin head and caliper body 160 until the height of the tool head or prongs immediately adjacent to the shaft of the pin is of sufficient height to preclude breaking the tool head when the tool is impacted. Once the engagement face 112 is thus securely engaged with the pin head, the user strikes the striking face 140 with a hammer or other object suitable for striking the face 140. The force from hitting the striking face 140 urges the caliper pin out of its mounting opening and out of the caliper body 160. Since the tool shaft 108 extends along an axis substantially parallel and only slightly offset from an axis of the caliper pin, the force exerted by hammering the striking face 140 runs close to the axis of the caliper pin. Consequently, the caliper pin is not subjected to a substantial torque, and the risk of damaging the caliper pin or the mounting opening in which the pin is situated is low during removal of the caliper pin. Additionally, the tool head 104 is configured such that a user can engage the pin with the tool head 104 from behind the caliper. As a result, the tool 100 can be easily engaged with a pin located on the back of a caliper while the caliper is mounted to the vehicle.

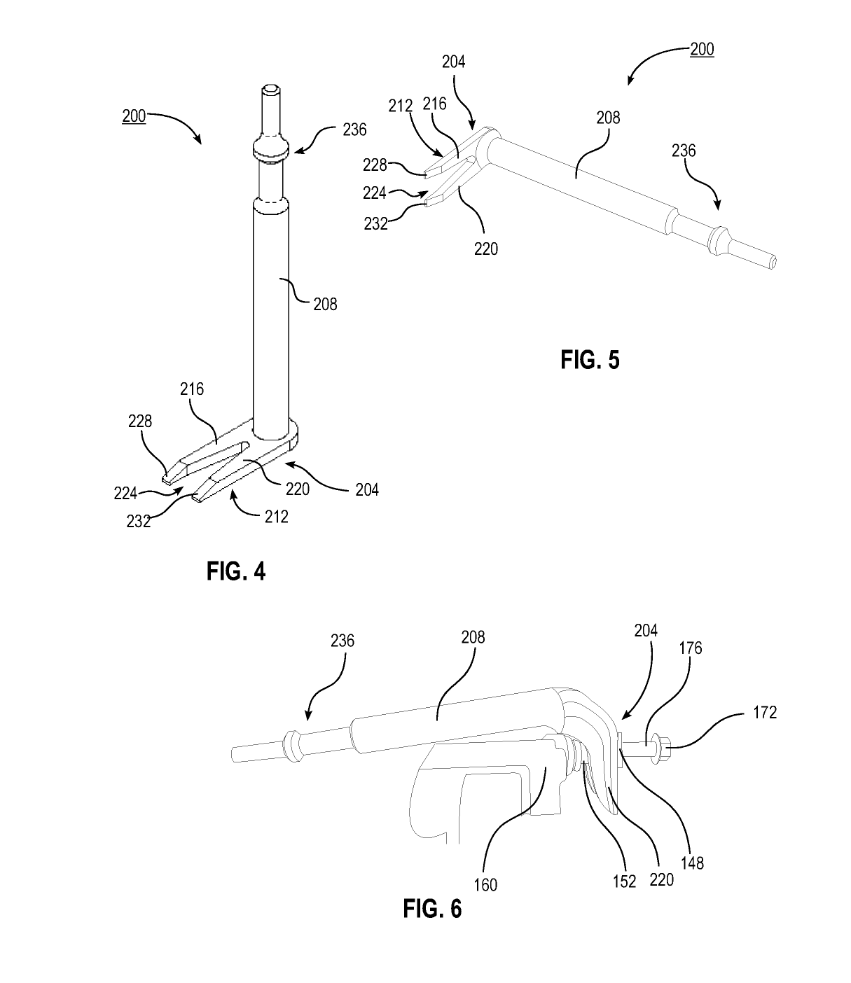

FIGS. 4 and 5 illustrate perspective views of another embodiment of a caliper pin removal tool 200. The pin removal tool 200 includes a head 204 and a shaft 208, the head 204 extending along a plane approximately orthogonal to a longitudinal axis of the shaft 208. In the embodiment of FIG. 5, the head 204 and the shaft 208 are separate pieces joined together by, for example, welding, though in the embodiment illustrated in FIG. 6, the head 204 and shaft 208 are integrally formed from a single piece of material.

The tool head 204 includes a generally flat engagement face 212, a first prong 216, and a second prong 220, both of which extend away from the intersection of the tool head 204 and shaft 208. The first prong 216 and second prong 220 extend substantially parallel to one another, and define an opening 224 therebetween. The prongs 216, 220 are tapered at end regions 228, 232 remote from the shaft 208 such that a height, defined parallel to the longitudinal axis of the shaft 208, is less at the ends 228, 232 of the prongs 216, 220. The prongs 216, 220 also have a tapered width, such that the width of the prongs 216, 220 is greater at the end nearest the intersection of the tool head 204 and shaft 208 than at the opposite ends 228, 232 of the prongs 216, 220. As a result, the opening 224 is narrower at the end near the intersection of the tool head 204 and shaft 208 than at the opposite end of the tool head 204.

The tool shaft 208 is substantially cylindrical in the embodiments of FIGS. 4 and 5, and includes a striking region configured as a pneumatic hammer interface 236 at an end remote from the intersection of the tool head 204 and shaft 208. The hammer interface 236 is shaped to enable a pneumatic hammer to engage the interface 236 and be securely attached to the shaft 208. In one embodiment, the pneumatic hammer interface 236 is a separate piece and is joined to the shaft 208 by any form of attachments. In another embodiment, the pneumatic hammer interface 236 and the shaft 208 are integrally formed. In other embodiments, the pneumatic hammer interface is replaced with an interface for another power tool, such as an electric hammer or a hammer drill. In some embodiments, the shaft includes a gripping portion similar to the one described above with regard to the embodiment of FIGS. 1-3. The optional gripping portion includes a surface that is altered or modified from the surface of the shaft 208 for enhanced grip of the tool 200.

FIG. 6 illustrates the tool 200 in use. The tool 200 is positioned such that the ends 228, 232 of the prongs 216, 220 are wedged between the head 148 of a caliper pin 152 and the body of the caliper 160. The tool head 204 is then pushed downwardly in the view of FIG. 6 until the engagement face 212 is securely engaged with the head 148 of the caliper pin 152. If the tool 200 cannot be wedged between the pin head 148 and the caliper 160 with manual force, the tool head 204 can be struck at the end near the shaft 208 to force the tool between the pin head 148 and caliper body 160. In this configuration, the prongs 216, 220 abut the head of the caliper pin while the shaft of the caliper pin is received within the opening 224.

Once the engagement face 212 is securely engaged with the pin head, the user attaches a pneumatic hammer (not shown) to the pneumatic hammer interface 236 of the shaft 208. The pneumatic hammer is activated, providing a repetitive striking force running along the axis of the tool shaft 208. The force from the pneumatic hammer urges the caliper pin 152 out of its mounting opening and out of the caliper body 160. Since the tool shaft 208 extends along an axis substantially parallel to and only slightly offset from an axis of the caliper pin, the force exerted by the pneumatic hammer runs close to the axis of the caliper pin 152. As a result, the caliper pin 152 is not subjected to a substantial torque, and there is little risk of damaging the caliper pin 152 or the mounting opening in which the pin 152 is situated during removal of the caliper pin 152.

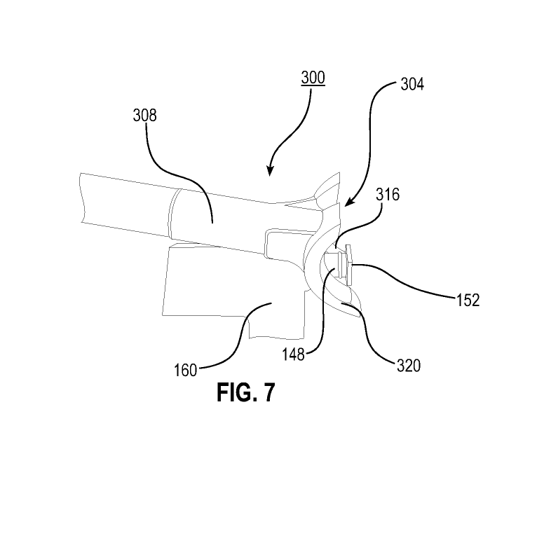

FIG. 7 illustrates another embodiment of a caliper pin removal tool 300. The embodiment of FIG. 7 is generally identical to the embodiments of FIGS. 1-2 and FIGS. 4-5, except that the tool head 304 and the prongs 316, 320 are arcuately shaped. The arcuate shape of the prongs 316, 320 enables the tool 300 to be wedged between the caliper pin 152 and the caliper 160 by pivoting the tool 300 about the intersection of the tool head 304 and shaft 308.

While the above embodiments have been described with reference to removal of caliper pins and mounting bolts, the reader should appreciate that the above-described tool is not limited to use on caliper pins and mounting bolts. The tool is suitable for removal of other bolts on a vehicle, for example suspension bolts, or removal of bolts and pins in other settings, such as industry or manufacturing.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the foregoing disclosure.

What is claimed is:

1. A pin removal tool comprising:
a tool head;
an opening defined in the tool head by a first and a second portion of the tool head, the opening extending inwardly from a side of the tool head and between a proximal surface and a distal surface, the opening sized to receive a shaft portion of a caliper pin therein while allowing the distal surface to abut a head of the caliper pin; and
a shaft having a longitudinal axis which is not parallel to the distal surface, the shaft including a first end portion rigidly connected to the tool head and a second end portion having a striking interface, the striking interface configured to receive an impact force and transmit the impact force along the longitudinal axis.

2. The pin removal tool of claim 1, wherein:
the tool head includes a base portion, a first prong, and a second prong;
the first prong extends from the base portion;
the second prong extends from the base portion;
the first prong and the second prong define at least a portion of the opening therebetween; and
the first prong and the second prong define at least a portion of the distal surface.

3. The pin removal tool of claim 2, wherein:
the first prong has a first end attached to the base portion and a second end opposite to the first end;
the second prong has a third end attached to the base portion and a fourth end opposite to the first end; and
a width of the opening decreases from a location proximate the second and fourth ends to a location proximate the first and third ends.

4. The pin removal tool of claim 3, wherein the distal surface of the tool head is generally planar and is positioned in a plane that is at an angle of between 80 and 100 degrees to the longitudinal axis.

5. The pin removal tool of claim 4, wherein the distal surface of the tool head is orthogonal to the longitudinal axis.

6. The pin removal tool of claim 3, wherein:
a height of the first prong along the longitudinal axis increases from a location proximate the second end to a location proximate the first end; and
a height of the second prong along the longitudinal axis increases from a location proximate the fourth end to a location proximate the third end.

7. The pin removal tool of claim 6, wherein the shaft includes a textured portion adjacent to the second end portion of the shaft.

8. The pin removal tool of claim 3, wherein the striking interface includes a striking surface generally orthogonal to the longitudinal axis.

9. The pin removal tool of claim 3, wherein the striking interface includes a pneumatic hammer interface configured to receive the impact force from a pneumatic hammer.

10. The pin removal tool of claim 3, wherein;
the distal surface of the tool head is arcuately shaped about a first axis of curvature that is generally orthogonal to the longitudinal axis; and
the proximal surface of the tool head is arcuately shaped about a second axis of curvature that is generally orthogonal to the longitudinal axis.

11. A method of removing a brake caliper pin comprising:
inserting a tool head between a head of a caliper pin and a body of a caliper such that a shaft portion of the caliper pin is received in an opening defined in the tool head by a first and a second portion of the tool head and between a proximal surface and a distal surface;
abutting the head of the caliper pin with the distal surface;
transmitting an axial force to a striking interface located at a first end portion of a shaft;
transferring the axial force along a longitudinal axis of the shaft from the first end portion to a second end portion of the shaft;
diverting the axial force from the second end portion to the tool head, which is rigidly connected to the second end portion; and
transmitting the axial force from the tool head to the head of the caliper pin through the abutment of the distal surface and the head of the caliper pin.

12. The method of claim 11, wherein the transmitting of the axial force to the striking interface includes impacting a planar surface that is generally orthogonal to the longitudinal axis of the shaft.

13. The method of claim 11, wherein the transmitting of the axial force to the striking interface includes:
attaching a pneumatic hammer to a pneumatic hammer interface of the striking interface; and
activating the pneumatic hammer to impact the pneumatic hammer interface.

14. The method of claim 11, wherein:
the inserting of the tool head includes inserting a first prong and a second prong, which define at least of a portion of the distal surface and of the opening, between the head of the caliper pin and the body of the caliper such that the first and second prongs engage opposite sides of the shaft portion of the caliper pin; and
the transmitting of the axial force from the tool head to the head of the caliper pin includes transmitting the axial force to the head of the caliper pin through the first prong and the second prong.

15. The method of claim 14, wherein:
the inserting of the tool head includes inserting the first prong from a first end toward a second opposite end attached to a base portion of the tool head and inserting the second prong from a third end to a fourth opposite end attached to the base portion of the tool head; and
the abutting of the head includes moving the first and second prongs such that the prongs move from a first portion of the opening proximate the first and third ends to a second portion of the opening proximate the second and fourth ends, the second portion of the opening having a width that is reduced from the first portion of the opening.

16. The method of claim 14, wherein the inserting of the tool head includes:
inserting a first end of the first prong, which has a reduced height compared to a second end of the prong, between the head of the caliper pin and the body of the caliper; and
inserting a third end of the second prong, which has a reduced height compared to a fourth end of the second prong, between the head of the caliper pin and the body of the caliper.
